(19) United States
(12) Patent Application Publication
(10) Pub. No.: US 2006/0232901 A1
(43) Pub. Date: Oct. 19, 2006

(54) Arrangement for protecting an electrical device

(75) Inventors: Gerd Bierbaum, Oberboihingen (DE); Jörg Huber, Durmersheim (DE); Rainer Mäckel, Königswinter (DE); Thomas Schulz, Unterensingen (DE)

Correspondence Address: FITCH, EVEN, TABIN & FLANNERY, P. O. BOX 65973, WASHINGTON, DC, 20035, US

(73) Assignee: DaimlerChrysler AG, Stuttgart (DE)

(21) Appl. No.: 10/565,881

(22) PCT Filed: Jul. 21, 2004
(86) PCT No.: PCT/EP04/08141

§ 371 Date: Apr. 5, 2006

(30) Foreign Application Priority Data
Jul. 26, 2003 (DE) 103 34 197.8

(51) Int. Cl. H02H 3/08

(52) U.S. Cl. 361/93.1

(57) ABSTRACT

The present invention relates to an arrangement (7) for protection of an electrical device. In this case, the device is connected via one pole terminal (4) to one pole (3) of a battery (1) . A protective contact unit (9) has a connecting section (10) which is connected directly to the pole terminal (4), and has a starting assistance contact section (11) which is connected to the connecting section (10) via a switch (12). An evaluation circuit (15) operates the switch (12) in order to disconnect the electrical connection between the starting assistance contact section (11) and the connecting section (10) as soon as the evaluation circuit (15) detects a fault current.

The present invention relates to an arrangement for protection of an electrical device having the features of the precharacterizing clause of claim 1. The invention also relates to a use of a protective arrangement such as this.

A large number of electrical and electronic components which may be damaged if subjected to polarity reversal are used in a large number of applications of electrical devices, in particular in vehicle power supply systems, for example in controllers. By way of example, electrolytic capacitors can be destroyed explosively if polarity reversal is applied. Furthermore, semiconductor power switches based on MOSFETs allow a high current to flow via their inverse diode if connected with inverse polarity, with this inverse diode being present in normal MOS transistors or MOS drivers. This undesirable high current flow can lead to destruction of the respective switch and/or to a load being unintentionally switched on. Bridge circuits are particularly critical in this context.

The use of electrolytic capacitors and semiconductor elements is, however, becoming increasingly important, especially in motor vehicle power supply systems. By way of example, electric motors are increasingly being subjected to open-loop or closed-loop control by means of pulse width modulation, for which purpose high switching frequencies are required which can be provided with the aid of semiconductor switches. Electrolytic capacitors are used in these applications in order to avoid damaging reactions on the vehicle power supply system.

By way of example, polarity reversal can occur in a vehicle power supply system when a motor vehicle battery is connected incorrectly. However, this risk is relatively small since a battery is normally installed by specialists. There is a very much higher risk of polarity reversal when a vehicle is intended to be used for starting assistance. Since starting assistance is generally carried out by unskilled persons, confusion can easily occur in this case between the battery poles and the jumper cables.

EP 0 725 412 A2 discloses a protective arrangement of the type mentioned initially which can be used in a motor vehicle to provide protection against fault currents for a power cable in the vehicle. The power cable is in this case connected to one pole of the vehicle battery, generally via one pole terminal. The known protective arrangement has an evaluation circuit which opens a pyrotechnic switch as soon as it detects a fault current. In the known protective arrangement, the switch is arranged in the power cable, so that its connection to the battery pole is disconnected as soon as the evaluation circuit detects a fault current.

DE 39 30 896 A1 discloses a polarity-reversal protective circuit which has a voltage input, a voltage output connected to it, a ground input and a ground output. This polarity-reversal protective circuit is preceded on its input side by an electrical device which is intended to be protected against destruction caused by polarity reversal. The polarity-reversal protective circuit has an MOSFET, which is operated in the inverse sense, between the ground input and the ground output, with its gate being connected to the voltage input. When the correct polarity is applied to the polarity-reversal protective circuit, the gate/source voltage switches on the MOSFET. The source is then connected to ground potential, while the gate is fed from the supply voltage. The ground line between the ground output and the ground input then has a virtually negligible resistance. However, if the voltage supply is connected with the incorrect polarity to the polarity-reversal protective circuit, the gate/source voltage is so small that the source/drain path is switched off. This reliably prevents current from flowing into the electrical device. However, a polarity-reversal protective circuit such as this is comparatively expensive.

DE 29 19 022 A1 discloses a polarity-reversal protective arrangement for a battery charging system which operates with a centrally switched relay. However, when switched on, the relay requires a relatively high drive power and, furthermore, has a relatively high resistance when switched on, so that a polarity-reversal protective arrangement such as this is not suitable for use in a motor vehicle, since a deterioration in the system characteristics must be expected when the battery is used to start the internal combustion engine. Furthermore, the high currents which can occur in a motor vehicle when a relay is being switched off result in a risk of erosion of the switching contacts.

Furthermore, DE 197 19 919 A1 discloses a protective arrangement for electrical devices, which proposes a limiting element which is connected in parallel with the vehicle power supply system and limits the vehicle power supply system voltage to a predetermined value if the voltage polarity is incorrect. Furthermore, a tripping unit is provided, which is triggered when a high current flows through the limiting element. This tripping unit may in this case have a bipolar transistor as well as a trigger for a disconnecting element. The collector of the bipolar transistor is connected to a positive pole terminal of a vehicle battery, while the emitter of the bipolar transistor is connected to the trigger. The base of the bipolar transistor is connected to the cathode of a diode, whose anode is connected via a resistance to a negative pole terminal of the vehicle battery, to which the trigger is also connected. In the event of polarity reversal, the bipolar transistor is operated in the inverse mode since in this case the voltage drop across the collector-emitter path of the transistor is at a minimum. This allows the trigger to be supplied with a sufficiently high current even when there is a small negative voltage across the limiting element. This arrangement is also comparatively complex.

The present invention is concerned with the problem of specifying an improved embodiment for a protective arrangement of the type mentioned in the introduction, which can in particular be implemented at low cost and ensures particularly good protection for the respective electrical device.

According to the invention, this problem is solved by the subject matters of the independent claims. Advantageous embodiments are the subject matter of the dependent claims.

The invention is based on the general idea, of arranging a switch directly adjacent to a pole terminal between a connecting section, which is connected to the pole terminal, and a starting assistance contact section which can make contact with a jumper cable in order to provide and receive starting assistance, which switch disconnects the electrical connection between the starting assistance contact section and the connecting section as soon as an evaluation circuit detects a fault current. It is particularly important in this case that the electrical device is connected to the pole terminal separately, that is to say bypassing the switch. If the polarity is incorrect, a fault current flows which the evaluation circuit identifies, so that it operates the switch in order to disconnect the electrical connection between the starting assistance contact section and the connecting section. The incorrect-polarity starting assistance contact section is then immediately disconnected from the pole terminal, and thus from the respective device.

In consequence, the fault current does not reach the device at all. An arrangement such as this can be implemented at low cost and is thus particularly suitable for large scale production use. It is also particularly important for the device to still be connected to the pole of the battery, and thus still to be operable, after the switch has been opened.

In one expedient development, the evaluation device can interact with a current sensor, which senses the current level and/or the current flow direction in a main line and is connected to the evaluation circuit in order to transmit a corresponding sensor signal. During starting, a starting signal transmitter produces a start signal and is connected to the evaluation circuit in order to transmit this start signal. The evaluation circuit can now use the sensor signal and the start signal to detect whether or not a fault current is present and, if appropriate, to open the switch as soon as it detects a fault current in the main line. This design makes it possible, for example, to protect a vehicle power supply system against damage when an attempt is made, for example, to use a vehicle with a 24 volt power supply system to provide starting assistance for a vehicle with a 12 volt power supply system.

In this embodiment, the main line leads to at least one second electrical device, for example to a starter and a generator or to a starter generator, and is connected to the starting assistance contact section, in which case the first device, for example a vehicle power supply system, is then connected to the pole terminal, bypassing the main line.

This refinement makes it possible to allow different current flow directions in the main line for specific operating states without this leading to operation of the switch. For example, the current flows in one direction through the main line during normal driving operation of the vehicle, that is to say during generator operation, while the current flows through the main line in the opposite direction during starting of the vehicle, that is to say during starter operation. The additional start signal is provided in order to ensure that the evaluation circuit does not assess the current flowing in the opposite direction as indicating reversed polarity.

According to one particularly advantageous development, the current sensor can be arranged on the main line in such a way that the starting assistance contact section is located between the current sensor and the switch. Fundamentally, the point at which the current sensor is arranged between the pole and the starter and/or generator along the main line is irrelevant for the current sensor. However, the arrangement according to the invention makes it possible for a vehicle which is equipped with the protective arrangement according to the invention to provide starting assistance for another vehicle. This is because the chosen arrangement means that the current does not flow in the opposite direction through the main line in the area of the current sensor when providing starting assistance, so that the switch is not operated even though the start signal transmitter is not producing a start signal.

In one particularly advantageous embodiment, a switching element in the evaluation circuit is an MOS driver, which has an inverse diode, in which case a diode arrangement for controlling the control line then comprises the inverse diode or is formed by the inverse diode itself. In this embodiment, the evaluation circuit is provided with increased functional density, in which case the protective arrangement can be produced at particularly low cost as a result of the multiple use of individual components, in this case of the inverse diode.

An electrically insulating cover can expediently be provided, completely covering the pole terminal except for the starting assistance contact section. This measures forces the user to make contact with the pole of the battery via the starting assistance contact section during a starting assistance process. This ensures that the protective arrangement according to the invention is not bypassed by accidental incorrect connection. This makes it possible to additionally enhance the protection for the respective device.

Further important features and advantages of the invention are disclosed in the dependent claims, in the drawings and in the associated description of the figures with reference to the drawings.

It is self-evident that the features which have been mentioned above and those which are still to be explained in the following text can be used not only in the respectively stated combination but also in other combinations or on their own without departing from the scope of the present invention.

One preferred exemplary embodiment of the invention is illustrated in the drawings and will be explained in more detail in the following description, with the same reference symbols relating to identical, functionally identical, or similar components.

In the figures, in each case schematically:

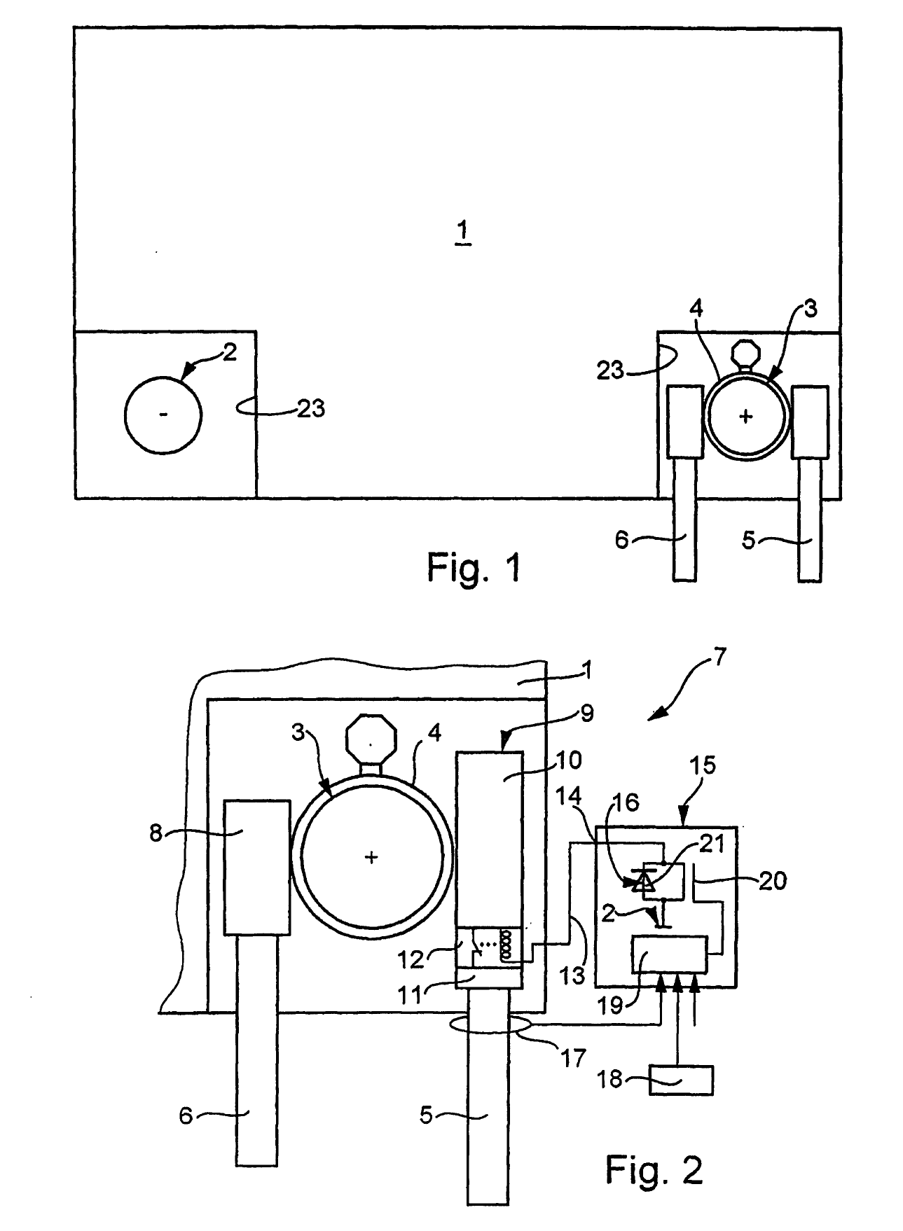

FIG. 1 shows an outline illustration of a plan view of a vehicle battery,

FIG. 2 shows an enlarged illustration, in the form of a wiring diagram, of one pole of the battery, and

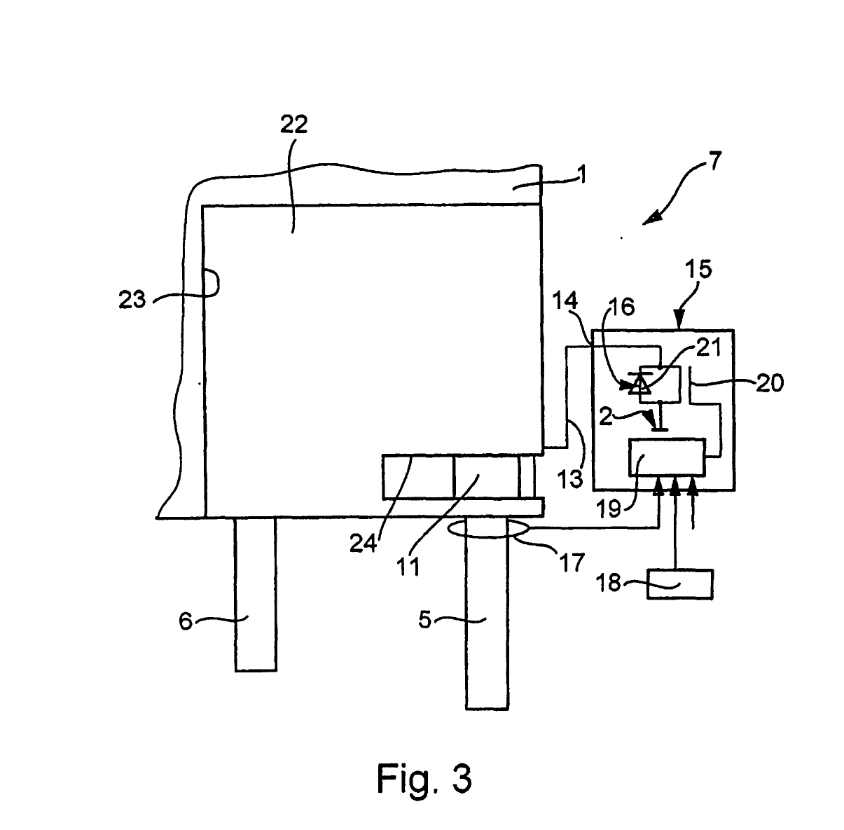

FIG. 3 shows a view corresponding to that in FIG. 2, but with a cover arranged in the area of the pole.

As can be seen from FIG. 1, a conventional battery 1, in this case by way of example a vehicle battery 1 for a motor vehicle which is otherwise not shown, has two poles, specifically a negative pole 2 and a positive pole 3. So-called pole terminals 4 are normally used for connection of electrical lines to the poles 2, 3, only one of which is illustrated here. In this case, two lines 5, 6 are connected to the illustrated pole terminal 4 independently of one another. The present invention will be explained in more detail in the following text with reference to FIGS. 2 and 3, on the basis of the positive pole 3. However, it is obvious that, in principle, the invention can also be implemented in an appropriately adapted manner on the negative pole 2.

As can be seen from FIG. 2, a protective arrangement 7 according to the invention has a pole terminal, in this case the pole terminal 4, which is connected to the positive pole 3 of the battery 1. The two lines 5, 6 which are connected to the pole terminal 4 are in this case formed by a main line 5 and a secondary line, or vehicle power supply system line 6. The secondary or vehicle power supply system line 6 leads to a first electrical device, which is not illustrated in any more detail and is expediently formed by a vehicle power supply system in the case of a vehicle. The vehicle power supply system line 6 is connected directly to the pole terminal 4 via a connecting element 8, that is to say bypassing the main line 5. In contrast to this, the main line 5 is connected indirectly to the pole terminal 4 via a protective contact unit 9. The main line 5 leads to a second electrical device, which is not shown, in the case of a vehicle expediently to a starter or to a generator in the vehicle. The main line 5 can likewise lead to a starter generator in the vehicle, which can be operated both in a starter mode and in a generator mode.

The protective contact unit 9 comprises a connecting section 10, a starting assistance contact section 11 and a switch 12. The connecting section 10 is electrically conductively connected on the one hand directly to the pole terminal 4 and on the other hand to the starting assistance contact section 11 via the switch 12. The main line 5 is electrically conductively connected to the starting assistance contact section 11. The switch 12 is designed such that, when operated, it disconnects the electrical connection between the starting assistance contact section 11 and the connecting section 10. The switch 12 is for this purpose coupled to an evaluation circuit 15, which is designed such that it identifies a fault current and opens the switch 12 when a fault current is present.

The switch 12 is associated with a control line 13 which is connected on the one hand to the connecting section 10 and on the other hand to a control output 14 of the evaluation circuit 15. The switch 12 is now designed such that it disconnects the electrical connection between the starting assistance contact section 11 and the connecting section 10 as soon as a predetermined current is flowing through the control line 13. The magnitude of the predetermined current is in this case expediently chosen such that parasitic effects do not initiate operation of the switch 12. For example, the switch 12 may be in the form of a relay which switches when current is flowing in the control line 13. By way of example, a solenoid is then arranged for this purpose in the control line 13 and switches a contact in the relay to any desired other switch position.

However, in one preferred embodiment, the switch 12 is in the form of a pyrotechnic explosive switch, which fires when current is flowing through the control line 13. In this embodiment, a heating section, in particular a heating filament or incandescent filament, can then be arranged in the control line 13, with this heating section being heated when current is flowing through the control line 13 and thus thermally firing the explosive switch 12. In principle, however, other suitable refinements are also possible for the switch 12.

Within the evaluation circuit 15, the control output 14 is electrically connected via a diode arrangement 16 to the opposing pole of the battery 1 which is the inverse of the pole of the pole terminal 4, that is to say in this case to the negative pole 2. The diode arrangement 16 is in this case chosen such that it is reverse-biased when the polarity of the pole terminals 4 is correct, and is forward-biased when the polarity is incorrect.

Furthermore, in the preferred embodiment of the protective arrangement 7 according to the invention shown here, a current sensor 17 is provided and is designed such that it senses the current flow direction, and expediently also the current level, in the main line 5, and generates a corresponding sensor signal. The current sensor 17 is connected to the evaluation circuit 15 in order to transmit the current signal. By way of example, the current sensor 17 may be in the form of a Hall sensor.

Furthermore, a start signal transmitter 18 is provided and, for example, forms a component of a vehicle starting system. The start signal transmitter 18 is designed such that it produces a start signal on starting of the vehicle, that is say during operation of the starter, and passes this start signal to the evaluation circuit 15. For this purpose, the evaluation circuit 15 is connected to the start signal transmitter 18. In addition, further devices may be connected to the evaluation circuit 15, for example a crash sensor system, which is not shown, can be used to transmit a crash signal to the evaluation circuit 15.

The evaluation circuit 15 now contains an evaluation unit 19 which evaluates the arriving signals and, for example, uses the sensor signal and the start signal to detect whether a correct current or a fault current is present. In the same way, the evaluation circuit 19 can check for the presence of further events that are relevant for operation of the switch 12, for example a crash situation.

The evaluation circuit 19 contains a switching element 20 which in this case is driven by the evaluation unit 19 when a fault current or some other event which requires the operation of the switch 12 occurs. When in the driven state, the switching element 20 can electrically connect the control output 14 to the opposing pole, that is to say in this case to the negative pole 2, bypassing the diode arrangement 16. A current then flows through the control line 13 in a corresponding manner when the switching element 20 is operated.

The switching element 20 is preferably an MOS driver which has an inverse diode 21. In the case of the present invention, the inverse diode 21 which is present in any case in the MOS driver 20 is advantageously used to form the diode arrangement 16. In the simplest case, the diode arrangement 16 is formed by the inverse diode 21 itself. However, if a lower reversed-polarity voltage is desirable, the diode arrangement 16 may additionally have at least one further diode, which is connected in parallel with the inverse diode 21, in addition to the inverse diode 21. An additional diode such as this is expediently in the form of a Schottky diode.

In principle, the current sensor 17 can be arranged at any desired point along the main line 5 between the pole terminal 4 and the starter or generator, in order to sense the magnitude and direction of the current flowing in it. However, in the case of the protective arrangement 7 according to the invention, the positioning of the current sensor 17 chosen here relative to the starting assistance contact section 11 is of particular importance. This is because, according to the invention, this positioning is designed in such a way that the starting assistance contact section 11 is located between the current sensor 17 and the pole to which the pole terminal 4 is connected, that is to say in this case the positive pole 3.

As can be seen from FIG. 3, one preferred development of the protective arrangement 7 according to the invention also has an electrically insulating cover 22, which is expediently fitted into a depression 23 (see also FIG. 1) which is formed for the respective pole 2, 3 on the battery 1. The cover 22 is in this case shaped such that it completely covers the respective pole 2, 3 as well as the entire pole terminal 4, with the exception of the starting assistance contact section 11. The cover 22 contains a cutout 24 for the starting assistance contact section 11, with the cutout 24 being of such a size that the starting assistance contact section 11 can be accessed by a terminal of a jumper cable. For example, the starting assistance contact section 11 projects through the cutout 24 upwards above the cover 22. The starting assistance contact section 11 can likewise be equipped with an extension section, which is not shown in any more detail here but is detachably connected to the starting assistance contact section 11, in particular such that it can be plugged in or detached, and projects beyond the pole terminal 4, the pole 3 and the connecting section 10 from the battery 1.

In one expedient embodiment, the complete evaluation circuit 15 and, in particular and in addition, the current sensor 17 can be integrated in the cover 22, or can be fitted to it. This results in the evaluation circuit 15 and the current sensor 17 being accommodated in a space-saving and protected form.

The protective arrangement 7 according to the invention operates as follows:

During normal operation of the motor vehicle, the generator supplies current via the main line 5 in order to supply the vehicle power supply system and in order to charge the battery 1. Since this is direct current, there is a specific current flow direction. This current direction is determined by the current sensor 17 and is signaled to the evaluation circuit 15. Since the vehicle is being operated in the generator mode, no starting process is taking place, so that the start signal transmitter 18 does not generate any start signal. The evaluation unit 19 uses this to identify that the present current direction matches the current direction desired for generator operation, and accordingly does not operate the switching element 20.

When the vehicle is being started, the starting mode is taking place, so that the start signal transmitter 18 generates a start signal, which is in general referred to as a “terminal 50 signal”, and transmits this to the evaluation circuit 15. During the starting operation, the starter is supplied with current from the battery 1, that is to say the current flows in the opposite direction to that during generator operation during starting operation. The current sensor 17 identifies the different current direction and signals this to the evaluation circuit 15. The evaluation unit 19 identifies that the current in the main line 5 is flowing in the incorrect current direction for generator operation, but also knows via the applied start signal that this is starting operation rather than generator operation. The evaluation unit 19 therefore once again does not drive the switching element 20.

If the incorrect current flow direction and/or the incorrect current level for the respective operating state of the vehicle were now to be present in the main line 5 as a result of damage or the like, this is identified by the evaluation unit 19, which then operates the switching element 20. The driven switching element 20 now produces an electrical connection between the control output 14 and the opposing pole, that is to say in this case the negative pole 2. In consequence, a current flows through the control line 13 and operates the switch 12 in order to disconnect the electrical connection between the starting assistance contact section 11 and the connecting section 10. In consequence, the main line 5 is disconnected from the vehicle power supply system line 6, as a result of which the vehicle power supply system is protected against fault currents in the main line 5. In the same way, in the event of a crash, the switching element 20 is operated via the evaluation unit 19, thus opening the switch 12.

One important factor in this case is that the vehicle power supply system remains connected to the battery 1 and thus remains fully operable, despite the switch 12 having been tripped or opened.

With regard to starting assistance, a distinction is drawn between active starting assistance, in which the vehicle that is equipped with the protective arrangement 7 is providing starting assistance to another vehicle, and passive starting assistance, in which the vehicle that is equipped with the protective arrangement 7 is being provided with starting assistance from another vehicle.

In the case of active starting assistance, incorrect polarity is relatively unproblematic for the vehicle providing the starting assistance, since the stronger battery 1 generally predetermines the current direction. When the polarity is correct during active starting assistance, this is where the special arrangement of the current sensor 17 relative to the starting assistance contact section 11 that has been chosen in this case comes to bear. In the case of active starting assistance, the vehicle that is equipped with the protective arrangement 7 is either switched off or is in the generator mode. In any case, it is not in the starting mode, so that no start signal is present. When current now flows via the starting assistance contact section 11 during active starting assistance, the chosen arrangement of the current sensor 17 and the starting assistance contact section 11 ensures that the current sensor 17 in the main line 5 cannot detect reversal of the current flow direction. The evaluation unit 19 in consequence assumes that the vehicle is switched off, or that the vehicle is in the generator mode.

The state during passive starting assistance with correct polarity is the same as that which also exists when the vehicle is being started without starting assistance with a full battery 1. However, if polarity reversal accidentally occurs during passive starting assistance, the diode arrangement 16 becomes forward-biased, so that a current flows through the control line 13, thus operating the switch 12 and disconnecting the starting assistance contact section 11 from the vehicle power supply system. The fault current can admittedly flow through the main line 5 to the generator or to the starter, but these components are generally sufficiently robust, or are protected against fault currents by their own protective measures.

The protective arrangement 7 according to the invention thus provides reverse-polarity protection and fault-current protection which can be implemented at particularly low cost for an electrical device, such as the power supply system in a vehicle.

1. An arrangement for protection of an electrical device
having a pole terminal (4) which is connected to one pole (3) of a battery (1) and to which the electrical device is connected,
having a protective contact unit (9) which has a connecting section (10) (which is electrically connected directly to the pole terminal (4)) and a starting assistance contact section (11), with the connecting section (10) and the starting assistance contact section (11) being electrically connected in series by means of an intermediate closed switch (12), and
having an evaluation circuit (15) which opens the switch (12) as soon as it detects a fault current, with
a main line (5) being provided, which is electrically connected to the starting assistance contact section (11) as a function of the switch position of the switch (12) and leads to at least one second electrical device, and
the first device being electrically connected to the pole terminal (4), bypassing the main line (5) and independently of the switch position of the switch (12).

2. The protective arrangement as claimed in claim 1, characterized
in that a current sensor (17) is provided, which senses the current level and/or the current flow direction in the main line (5) and is connected to the evaluation circuit (15) in order to transmit a corresponding sensor signal,
in that the current sensor (17) is arranged on the main line (5) in such a way that the starting assistance contact section (11) is located between the current sensor (17) and the switch (12).

3. The protective arrangement as claimed in claim 1, characterized in that a secondary line (6) is provided, which leads to the first device and is connected to the pole terminal (4) independently of the main line (5).

4. The protective arrangement as claimed in claim 1, characterized by at least one of the following features:
in that the switch (12) disconnects the electrical connection between the starting assistance contact section (11) and the connecting section (10) as soon as a predetermined current is flowing through a control line (13),
in that the control line (13) electrically connects one control output (14) of an evaluation circuit (15) to the connecting section (10),
in that the control output (14) in the evaluation circuit (15) is electrically connected via a diode arrangement (16) to an opposing pole (2), which is the inverse of the pole (3) of the pole terminal (4),
in that the diode arrangement (16) is reverse-biased when connected in the correct direction, and is forward-biased when connected incorrectly,
in that a start signal transmitter (18) is provided, which produces a start signal during starting and is connected to the evaluation circuit (15) for transmission of the start signal,
in that the evaluation circuit (15) uses the sensor signal and the start signal to detect whether a fault current is present,
in that the evaluation circuit (15) drives a switching element (20) as soon as it detects a fault current in the main line (5),
in that the switching element (20) electrically connects the drive output (14) to the opposing pole (2) in the driven state, bypassing the diode arrangement (16),
in that the switching element is an MOS driver (20) which has an inverse diode (21),
in that the diode arrangement (16) in the control line (13) comprises the inverse diode (21) or is formed by the inverse diode (21), and
in that the diode arrangement (16) comprises the inverse diode (21) as well as at least one further diode connected in parallel with it, in particular a Schoftky diode.

5. The protective arrangement as claimed in claim 1, characterized in that an electrically insulating cover (22) is provided and completely covers the pole terminal (4) except for the starting assistance contact section (11).

6. The protective arrangement as claimed in claim 5, characterized in that the starting assistance contact section (11) has an extension section which projects beyond the pole terminal (4) and/or beyond the pole (3) from the battery (1).

7. The protective arrangement as claimed in claim 5, characterized in that the evaluation circuit (15) and/or the current sensor (17) are/is arranged within an area which is bounded by the cover (22).

8. The protective arrangement as claimed in claim 1, characterized
in that the switch (12) is in the form of a relay which switches when current is flowing through the control line (13), or
in that the switch (12) is in the form of a pyrotechnic explosive switch which fires when current is flowing through the control line (13).

9. The protective arrangement as claimed in claim 8, characterized in that the control line (13) contains a heating section which is heated when current is flowing through it and fires the explosive switch (12).

10. The protective arrangement as claimed in claim 1, characterized
in that the first device is a vehicle power supply system in a motor vehicle, and/or
in that the second device comprises a starter and a generator in a motor vehicle, or is a starter generator in a motor vehicle.

11. The protective arrangement as claimed in one of claim 1, characterized in that the protective arrangement is used in a motor vehicle for protection of a vehicle power supply system against fault currents while providing and receiving starting assistance.
